(19) United States
(12) Patent Application Publication
(10) Pub. No.: US 2005/0094972 A1
(43) Pub. Date: May 5, 2005

(54) Data processing system and method

(75) Inventor: Stuart A. Green, Sheffield (GB)

Correspondence Address: WILMER CUTLER PICKERING HALE AND DORR LLP, 60 STATE STREET, BOSTON, MA, 02109, US

(73) Assignee: Zoo Digital Group Plc

(21) Appl. No.: 10/757,191

(22) Filed: Jan. 14, 2004

(30) Foreign Application Priority Data
Nov. 5, 2003 (GB) GB 0325822.5

(51) Int. Cl. H04N 5/781

(52) U.S. Cl. 386/94; 386/125

(57) ABSTRACT

Embodiment provide an authoring method for use in creating an audiovisual product, comprising the steps of: defining a plurality of components, the components implicitly representing functional sections of audiovisual content with respect to one or more raw content objects, and a plurality of transitions that represent movements between the plurality of components; expanding the plurality of components and the plurality of transitions to provide a set of explicitly realised AV assets and an expanded intermediate data structure of nodes and links, where each node is associated with an AV asset of the set and the links represent movement from one node to another; creating an audiovisual product in a predetermined output format, using the AV assets and the expanded intermediate data structure of the nodes and the links; and testing the audiovisual product.

### FIELD OF THE INVENTION

The present invention relates in general to a data processing method and system.

### BACKGROUND TO THE INVENTION

In general terms, it is desired to assemble many small sections of raw audio and video content (i.e. sound clips and video clips) to form a finished audiovisual product, by way of an authoring process. However, in many environments a considerable degree of specialist knowledge and time must be invested in the authoring process in order to achieve a desirable finished audiovisual product. These problems are exacerbated where the audiovisual product has a complex navigational structure or requires many separate raw content objects.

As a simple example, a feature movie or television program typically has a straightforward linear navigational sequence of individual scenes. By contrast, it is now desired to develop new categories of audiovisual products which have a much more complex navigational structure, such as a movie with many scene choices or different movie endings, and/or which have a large number of individual scenes, such as an interactive quiz game with say one thousand individual quiz questions.

An optical disc is a convenient storage media for many different purposes. A digital versatile disc (DVD) has been developed with a capacity of up to 4.7 Gb on a single-sided single-layer disc, and up to 17 Gb on a double-sided double-layer disc. There are presently several different formats for recording data onto a DVD disc, including DVD-video, DVD-audio, and DVD RAM, amongst others. Of these, DVD-video is particularly intended for use with pre-recorded video content, such as a motion picture. As a result of the large storage capacity and ease of use, DVD discs are becoming popular and commercially important. Conveniently, a DVD-video disc is played using a dedicated playback device with relatively simple user controls, and DVD players for playing DVD-video discs are becoming relatively widespread. More detailed background information concerning the DVD-video specification is available from DVD Forum at www.dvdforum.org.

Although DVD-video discs and DVD-video players are becoming popular and widespread, at present only a limited range of content has been developed. In particular, a problem arises in that, although the DVD specification is very flexible, it is also very complex. The process of authoring content into a DVD-video compatible format is relatively expensive and time consuming. In practice, the flexibility and functions allowed in the DVD-video specification are compromised by the expensive and time consuming authoring task. Consequently, current DVD-video discs are relatively simple in their navigational complexity. Such simplicity can impede a user's enjoyment of a DVD-video disc, and also inhibits the development of new categories of DVD-video products.

An example DVD authoring tool is disclosed in WO 99/38098 (Spruce Technologies) which provides an interactive graphical authoring interface and data management engine. This known authoring tool requires a relatively knowledgeable and experienced operator and encounters difficulties when attempting to develop an audiovisual product having a complex navigational structure. In particular, despite providing a graphical user interface, the navigational structure of the desired DVD-video product must be explicitly defined by the author. Hence, creating a DVD-video product with a complex navigational structure is expensive, time-consuming and error-prone.

Furthermore, there are typically three types of testing that are undertaking to test DVD products. These three types of testing aim to test (1) functionality, (2) quality and (3) compatibility. The functionality testing of a DVD product aims to confirm that the navigation paths through the various menus and, ultimately, to the various digital content, is as intended. This test is typically achieved by a person using the disc and performing a number of tests and checks dictated by, for example, a functionality test plan. The functionality test plan comprises a list of features or actions that a user of a disc under test should be able to perform. The test plan investigates whether or not various tests have been met and whether or not the response to various actions were as anticipated. The functionality test plan might be used in conjunction with a flowchart that shows the navigation paths through the menus and various audiovisual assets stored on the test disc.

It will be appreciated that this is a labour intensive and time-consuming process. As the navigation complexity of the content of a DVD increases and as the number of assets used by the navigation structure or navigation process increases, it becomes impractical to test every possible navigation path. Therefore, a tester usually concentrates on a statistically significant subset of all possible navigation paths of the disc in determining whether or not the disc meets the test plan. However, using a small sample or test space to decide whether or not a disc operates as intended is risky in that errors might still exist in some untested portions of the content.

It is an object of embodiment of the present invention at least to mitigate some of the problems of the prior art.

### SUMMARY OF INVENTION

In a first aspect of the present invention there is provided an authoring method for use in creating an audiovisual product, comprising the steps of: defining a plurality of components, the components implicitly representing functional sections of audiovisual content with respect to one or more raw content objects, and a plurality of transitions that represent movements between the plurality of components; expanding the plurality of components and the plurality of transitions to provide a set of explicitly realised AV assets and an expanded intermediate data structure of nodes and links, where each node is associated with an AV asset of the set and the links represent movement from one node to another; creating an audiovisual product in a predetermined output format, using the AV assets and the expanded intermediate data structure of the nodes and the links; and testing the audiovisual product.

In one preferred embodiment, the present invention relates to authoring of audiovisual content into a form compliant with a specification for DVD-video and able to be recorded on an optical disc recording medium.

In a second aspect of the present invention there is provided an authoring method for use in creating a DVD-video product, comprising the steps of: creating a plurality of components representing parameterised sections of audiovisual content, and a plurality of transitions representing movements between components; expanding the plurality of components and the plurality of transitions to provide a set of AV assets and an expanded data structure of nodes and links, where each node is associated with an AV asset of the set and the links represent movement from one node to another; creating a DVD-video format data structure from the AV assets, using the nodes and links; and testing the DVD-video format data structure.

In a third aspect of the present invention there is provided an authoring method for use in creating an audiovisual product according to a DVD-video specification, comprising the steps of: generating a set of AV assets each comprising a video object, zero or more audio objects and zero or more sub-picture objects, and an expanded data structure of nodes and links, where each node is associated with one AV asset of the set and the links represent navigational movement from one node to another; and creating a DVD-video format data structure from the set of AV assets, using the nodes and links; the method characterised by the steps of: creating a plurality of components and a plurality of transitions, where a component implicitly defines a plurality of AV assets by referring to a presentation template and to items of raw content substitutable in the presentation template, and the plurality of transitions represent navigational movements between components; expanding the plurality of components and the plurality of transitions to generate the set of AV assets and the expanded data structure of nodes and links; and testing the set of AV assets and the expanded data structure of nodes and links.

In another aspect the present invention there is provided a recording medium having recorded thereon computer implementable instructions for performing any of the methods defined herein.

In yet another aspect of the present invention there is provided a recording medium having recorded thereon an audiovisual product authored according to any of the methods defined herein.

Advantageously, embodiments can provide a convenient and simple method and apparatus for authoring an audio-visual product.

Preferred embodiments provide a method and apparatus able to create an audio-visual product having a complex navigational structure and/or having many individual content objects, whilst reducing a time required for authoring and minimising a need for highly skilled operators.

Preferably, there is provided an authoring tool which is intuitive to use and is highly flexible.

Particularly preferred embodiments support creation of audio-visual products such as DVD-video products that run on commonly available DVD-video players.

Accordingly, a first aspect of embodiments of the present invention provides a data processing system comprising a controller for processing a data stream comprising data representing at least one of a first video sequence (digitised video data) having associated identification data (unique identifier embedded in the user_data field) and associated navigation data; means (identifier extractor) to identify the associated identification data; a correlator (Navigation enumerator and identifier index) to correlate the identification data with a template (test plan) comprising data representing an abstraction of the first video sequence and the navigation data to determine whether or not there is a predetermined correlation, expressed in the template, between the data stream, or first video sequence, and the data contained within the template.

Advantageously, embodiments of the present invention allow at least the functionality of, for example, a DVD or DVD-video image data to be tested. It will be appreciated that this might allow significant savings to be made both in terms of time spent testing and labour charges associated with that testing. Furthermore, it also carries the additional possible benefit of DVD's being tested more thoroughly, which should, in turn, ensure that the user's experience of that DVD is not impaired by any errors.

### BRIEF DESCRIPTION OF THE DRAWINGS

Embodiments of the present invention will now be descried, by way of example only, with reference to the accompanying drawings in which:

FIG. 1 is an overview of an authoring method according to a preferred embodiment;

FIG. 2 is a schematic diagram showing a simple abstraction of a desired audiovisual product;

FIG. 3 shows in more detail a component used as part of the abstraction of FIG. 2;

FIG. 4 illustrates an example prior art authoring method compared with an example preferred embodiment;

FIG. 5 depicts another example embodiment of the present authoring method using components and transitions;

FIG. 6 shows the example of FIG. 5 in a tabular format;

FIG. 7 is an overview of a method for evaluating components and transitions;

FIG. 8 depicts evaluation of components in more detail;

FIG. 9 shows evaluation of transitions in more detail;

FIG. 10 illustrates a portion of an expanded data structure during evaluation of components and transitions;

FIG. 11 is an overview of a preferred method for creating DVD-video structures from an expanded data structure;

FIG. 12 shows a step of creating DVD video structure locations in more detail;

FIG. 13 depicts a step of creating DVD-video compatible data structures in more detail; and

FIG. 14 shows, schematically, a typical home entertainment system comprising a DVD player, a DVD and a television;

FIG. 15 illustrates a first embodiment at least part of the present invention; and

FIG. 16 shows a first aspect of testing a DVD according to an embodiment.

### DETAILED DESCRIPTION OF THE PREFERRED EMBODIMENTS

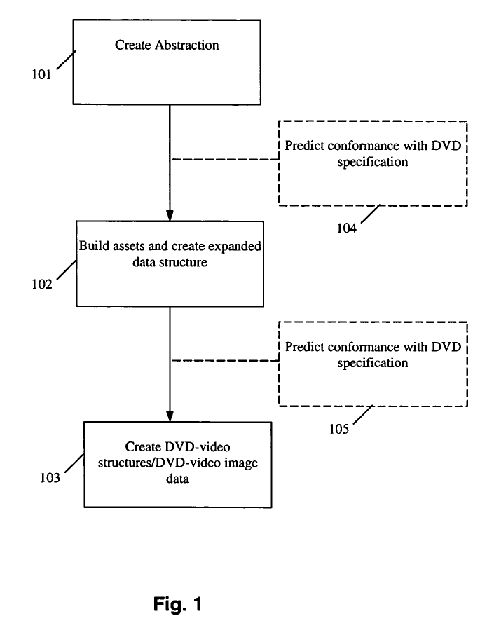

FIG. 1 shows an overview of an authoring method according to a preferred embodiment of the present invention. The embodiments of the present invention are applicable when authoring many types of audiovisual content or products, and in particular when complex navigational structure or content are involved.

As one example, embodiments of the present invention are applicable to authoring of video-on-demand products delivered remotely from a service provider to a user, such as over a computer network or other telecommunications network. Here, the embodiments of present invention are especially useful in authoring interactive products, where user choices and responses during playback of the product dictate navigational flow or content choices.

As another example, embodiments of the present invention are particularly suitable for use in the authoring of an audiovisual product or audio visual content compliant with a DVD-video specification. This example will be discussed in more detail below in order to illustrate the preferred arrangements of present invention. The audiovisual product can be, for example, recorded onto a medium such as an optical disk or magnetic medium. The DVD-video specification defines a series of data objects that are arranged in a hierarchical structure, with strict limits on the maximum number of objects that exist at each level of the hierarchy. Hence, in one preferred embodiment of the present invention it is desired to create an audiovisual product or audiovisual content which meets these and other limitations of the specification. In particular it is desired that the resultant audiovisual product will play on commonly available DVD players. However, it is also desired to create the audiovisual product having a complex navigational structure, to increase a user's enjoyment of the product, and in order to allow the creation of new categories of audiovisual products.

In the field of DVD-video, audiovisual content is considered in terms of audio-visual assets (also called AV assets or presentation objects) . According to the DVD-video specification each AV asset contains at least one video object, zero or more audio objects, and zero or more sub-picture objects. That is, a section of video data is presented along with synchronised audio tracks and optional sub-picture objects. The current DVD-video specification allows up to eight different audio tracks (audio streams) to be provided in association with up to nine video objects (video streams). Typically, the video streams represent different camera angles, whilst the audio streams represent different language versions of a soundtrack such as English, French, Arabic etc. Usually, only one of the available video and audio streams is selected and reproduced when the DVD-video product is played back. Similarly, the current specification allows up to thirty-two sub-picture streams, which are used for functions such as such as language subtitles. Again, typically only one of the sub-picture streams is selected and played back to give, for example, a movie video clip with English subtitles from the sub-picture stream reproduced in combination with a French audio stream. Even this relatively simple combination of video, audio and sub-picture streams requires a high degree of co-ordination and effort during authoring to achieve a finished product such as a feature movie. Hence, due to the laborious and expensive nature of the authoring process there is a strong disincentive that inhibits the development of high-quality audiovisual products or content according to the DVD-video specification. There is then an even stronger impediment against the development of audiovisual products or content with complex navigational flow or using high numbers of individual raw content objects.

Conveniently, the authoring methods of embodiments of the present invention are implemented as a program or a suite of programs. The program or programs are recorded or stored on or in any suitable medium, including a removable storage such as a magnetic disk, hard disk or solid state memory card, or as a signal modulated onto a carrier for transmission on any suitable data network, such as the Internet.

In use, the authoring method is suitably performed on a computing platform, like a general-purpose computing platform such as a personal computer or a client-server computing network. Alternatively, the method may be implemented, wholly or at least in part, by dedicated authoring hardware.

As shown in FIG. 1, the authoring method of the preferred embodiment of the present invention comprises three main stages, namely: creating a high-level abstraction (or storyboard) representing functional sections of a desired audiovisual product in step 101; automatically evaluating the high-level abstraction to create a fully expanded intermediate structure and a set of AV assets in step 102; and creating an output data structure compliant with a DVD-video specification using the expanded intermediate structure and AV assets in step 103. Preferably, the output data structure can then recorded onto a recording medium, such as, for example, a digital linear tape that can be used, to create a DVD-video product using glass master created using the content of the digital linear tape.

The method outlined in FIG. 1 will now be explained in more detail.

Firstly, looking at the step 101 of FIG. 1, the high-level abstraction is created by forming a plurality of components that implicitly represent functional elements of a desired DVD-video product, and a set of transitions that represent movements, that is, navigation, between the components that will occur during playback.

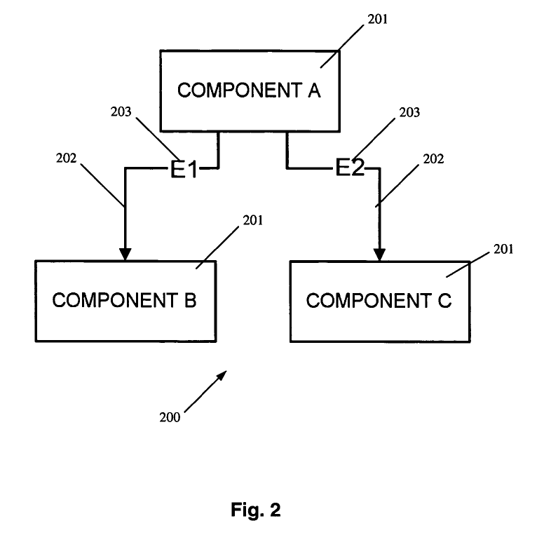

FIG. 2 is a schematic diagram showing a simple abstraction of a desired audiovisual product. In the example of FIG. 2 there are three components 201, linked by two transitions 202. The components 201 represent functional elements of the desired audiovisual product, where one or more portions of AV content (combinations of video clips, audio clips, etc) are to be reproduced during playback. The transitions 202 indicate legitimate ways of moving from one component to another during playback. In the example of FIG. 2, the transitions 202 are all explicitly defined. Suitably, each transition 202 is associated with an event 203, which indicates the circumstances giving rise to that transition. An event 203 is a triggering action such as the receipt of a user command, or the expiry of a timer, that influences movement through the sections of AV content during playback. Referring to FIG. 2, starting from a particular component A, and given all possible actions, exactly one event 203 will be satisfied, allowing a transition 202 from the current component A to a next component B or C.

The preferred embodiments provide three different types of component. These are an information component, a choice component and a meta-component.

An information component represents what will in due course become a single AV asset in the desired audiovisual product. Suitably, an information component simply comprises a reference to a raw content object or collection of raw content objects (i.e. raw video and audio clips, image stills or other digital content) that will be used to create an AV asset in the audiovisual product. For example, an information component refers to a welcome sequence that is displayed when the DVD-video product is played in a DVD-video player. The same welcome sequence is to be played each time playback begins. It is desired to display the welcome sequence, and then proceed to the next component. An information component (which can also be termed a simple component) is used principally to define presentation data in the desired DVD-video product.

A choice component represents what will become a plurality of AV assets in the desired audiovisual product. In the preferred embodiment, the choice component (alternately termed a multi-component) comprises a reference to at least one raw content object, and one or more parameters. Here, for example, it is desired to present a welcome sequence in one of a plurality of languages, dependent upon a language parameter. That is, both a speaker's picture (video stream) and voice track (audio stream) are changed according to the desired playback language. Conveniently, a choice component is used to represent a set of desired AV assets in the eventual audiovisual product, where a value of one or more parameters is used to distinguish between each member of the set. Hence, a choice component represents mainly presentation data in a desired DVD-video product, but also represents some navigational structure (i.e. selecting amongst different available AV assets according to a language playback parameter).

A meta-component comprises a procedurally-defined structure representing a set of information components and/or a set of choice components, and associated transitions. Conveniently, a meta-component may itself define subsidiary meta-components. A meta-component is used principally to define navigational structure in the desired audiovisual product by representing other components and transitions.

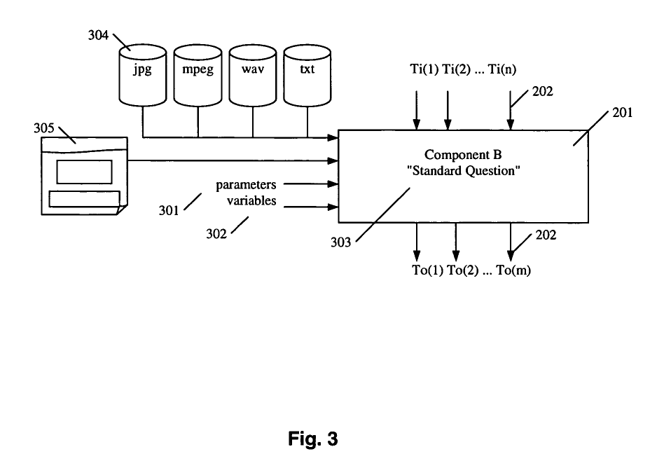

FIG. 3 shows a choice component or information component 201 in more detail. The component is reached by following one of a set of incoming transitions 202, labelled Ti(1 . . . n), and is left by following one of a set of outgoing transitions To(1 . . . m). The set of incoming transitions 202 might comprise one or more than one incoming transition. The set of outgoing transitions might comprise one or more than one outgoing transition.

The component 201 is defined with reference to zero or more parameters 301, which are used only during the authoring process. However, the component 201 may also be defined with reference to zero or more runtime variables 302. Each variable 302 records state information that can be read and modified within the scope of each component, during playback of the audiovisual product such as in a standard DVD player. Conveniently, the component 201 is provided with a label 303 for ease of handling during the authoring process.

The component 201 contains references to one or more items of content 304. The items of content are raw multi-media objects (still picture images, video clips, audio clips, text data, etc.) recorded in one or more source storage systems such as a file system, database, content management system, or asset management system, in any suitable format such as, for example, .gif, .tif, .bmp, .txt, .rtf, .jpg, .mpg, .qtf, .mov, .wav, .rm, .qtx, amongst many others. It will be appreciated that these raw content objects are not necessarily at this stage in a format suitable for use in the DVD-video specification, which demands that video, audio and sub-picture objects are provided in selected predetermined formats (i.e. MPEG).

Each component 201 uses the references as a key or index that allows that item of content to be retrieved from the source storage systems. The references may be explicit (e.g. an explicit file path), or may be determined implicitly, such as with reference to values of the parameters 301 and/or variables 302 (i.e. using the parameters 301 and/or variables 302 to construct an explicit file path).

Conveniently, the component 201 also preferably comprises a reference to a template 305. The template 305 provides, for example, a definition of presentation, layout, and format of a desired section of AV content to be displayed on screen during playback. A template 305 draws on one or more items of content 304 to populate the template. Typically, one template 305 is provided for each component 201. However, a single template 305 may be shared between a number of components 201 or vice versa. A template 305 is provided in any suitable form, such as, for example, as an executable program, a plug-in or an active object. A template is conveniently created using a programming language such as C++, Visual Basic, Shockwave or Flash, or by using a script such as HTML or Python, amongst many others. Hence, it will be appreciated that a template allows a high degree of flexibility in the creation of AV assets for a DVD-video product. Also, templates already created for other products (such as a website) may be reused directly in the creation of another form of audiovisual product, in this case a DVD-video product content.

The parameters 301, runtime variables 302, content items 304 and template 305 together allow one or more AV assets to be produced for use in the desired audiovisual product. Advantageously, creating a component 201 in this parameterised form allows a number, which might be a large number, large plurality of AV assets to be represented simply and easily by a single component.

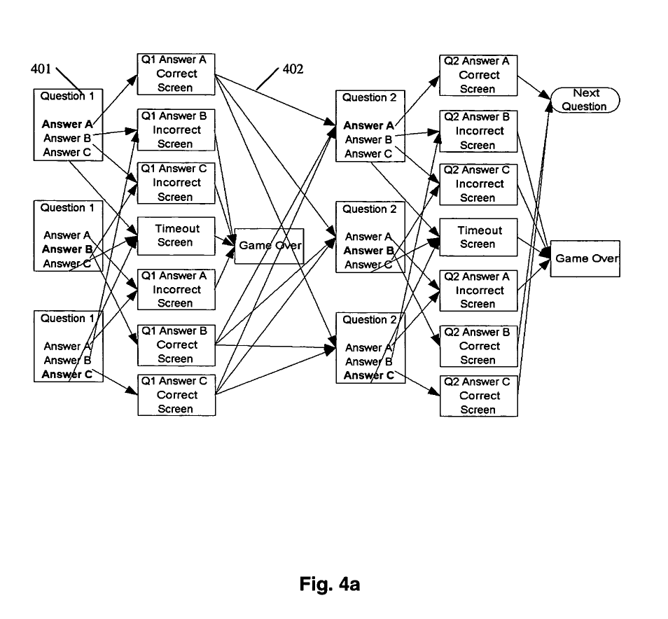

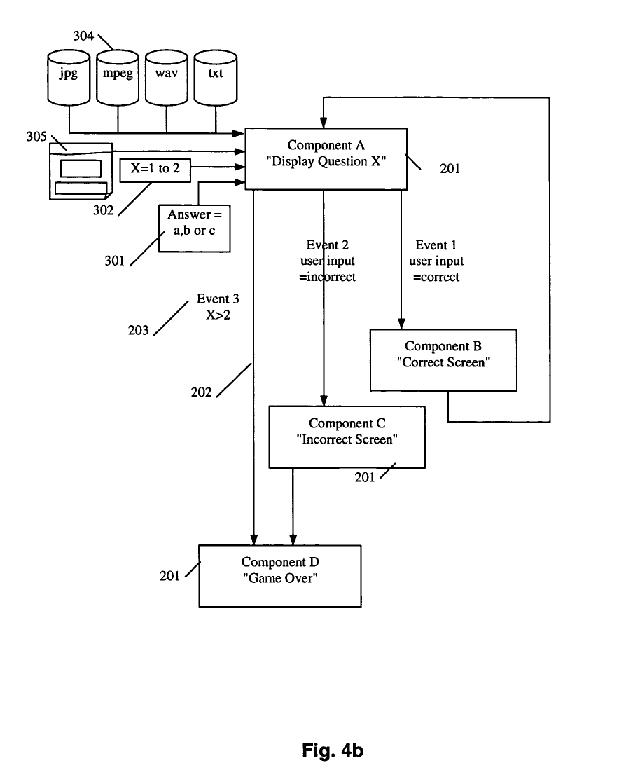

To illustrate the power and advantages of creating components 201 and transitions 202 as described above, reference will now be made to FIG. 4 which compares a typical prior art method for authoring an audiovisual product against preferred embodiments of the present invention. In this example, it is desired to develop an audiovisual product that allows the user to play a simple quiz game.

In FIG. 4a, each AV asset 401 that it is desired to present in the eventual audiovisual product must be created in advance and navigation between the assets defined using navigation links represented by arrows 402. Here, the game involves answering a first question and, if answered correctly, then answering a second question. The answer to each question is randomised at runtime using a runtime variable such that one of answers A, B and C is correct, whilst the other two are incorrect. In this simple example of FIG. 4a it can be seen that a large number of assets need to be created, with an even greater number of navigational links. Hence, the process is relatively expensive and time consuming, and is prone to errors.

FIG. 4b shows an abstraction, using components and transitions as described herein, for an equivalent quiz game. It will be appreciated that the abstraction shown in FIG. 4b remains identical even if the number of questions increases to ten, twenty, fifty or some other number of questions, whereas the representation in FIG. 4a becomes increasingly complex as each question is added.

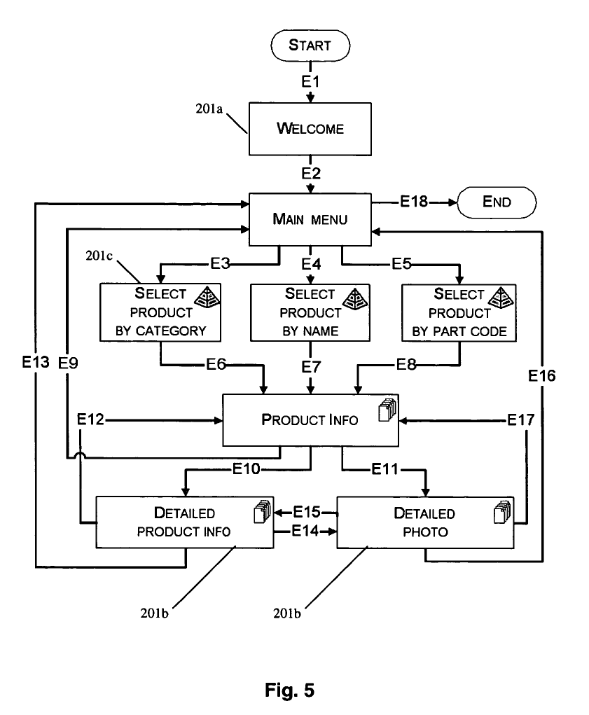

FIG. 5 shows another example abstraction using components and transitions. FIG. 5 illustrates an example abstraction for an audiovisual product that will contain a catalogue of goods sold by a retail merchant. A welcome sequence is provided as an information component 201a. Choice components 201b are used to provide a set of similar sections of AV content such as summary pages of product information or pages of detailed product information including photographs or moving video for each product in the catalogue. Here, the catalogue contains, for example, of the order of one thousand separate products, each of which will result in a separate AV asset in the desired DVD-video product. Meta-components 201c provide functions such as the selection of products by category, name or by part code. These meta-components are procedurally defined.

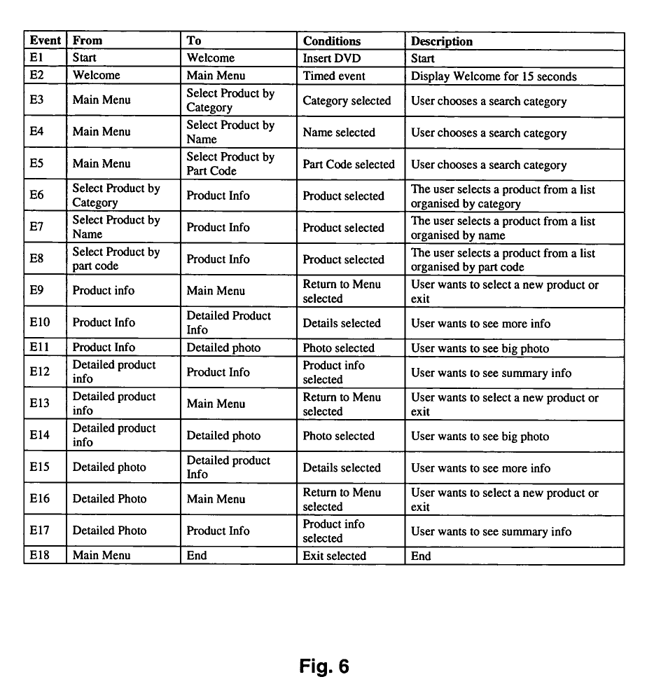

FIG. 6 shows a tabular representation for the abstraction shown in schematic form in FIG. 5.

In use, the authoring method and apparatus suitably presents a convenient user interface for creating components and transitions of the high-level abstraction. Ideally, a graphical user interface is provided allowing the definition of components, transitions and events, similar to the schematic diagram of FIG. 5. Most conveniently, the user interface provides for the graphical creation of components such as by drawing boxes and entering details associated with those boxes, and defining transitions by drawing arrows between the boxes and associating events with those arrows. Alternatively, a tabular textual interface is provided similar to the table of FIG. 6.

Referring again to FIG. 1, the abstraction created in step 101 is itself a useful output. The created abstraction may be stored for later use or may be transferred to another party for further work. However, in most cases the authoring method is used to automatically create a final audiovisual product, such as a DVD-video product, from the abstraction.

Referring to FIG. 1, the method optionally includes the step 104 of checking for compliance with a DVD specification. It is desired to predict whether the resulting DVD-video product will conform to a desired output specification, in this case the DVD-video specification. For example, the DVD-video specification has a hierarchical structure with strict limits on a maximum number of objects that may exist at each level, and limits on the maximum quantity of data that can be stored on a DVD-video disc.

In one embodiment, the checking step 104 is performed using the created components 201 and transitions 202. As discussed above, the components 201 contain references to raw AV content objects 304 and templates 305, and authoring parameters 301, 302, that allow AV assets to be produced. The checking step 104 comprises predicting a required number of objects at each level of the hierarchical structure, by considering the number of potential AV assets that will be produced given the possible values of the authoring parameters (i.e. authoring-only parameters 301 and runtime variables 302), and providing an indication of whether the limits for the maximum number of objects will be exceeded. Similarly, where a component defines a set of similar AV assets, then it is useful to predict the physical size of those assets and to check that the audiovisual product is expected to fit within the available capacity of a DVD disc. Advantageously, the conformance check of step 104 is performed without a detailed realisation of every AV asset, whilst providing an operator with a reasonably accurate prediction of expected conformance. If non-conformance is predicted, the operator may then take steps, at this early stage, to remedy the situation. As a result, it is possible to avoid unnecessary time and expense in the preparation of a full audiovisual product which is non-conformant.

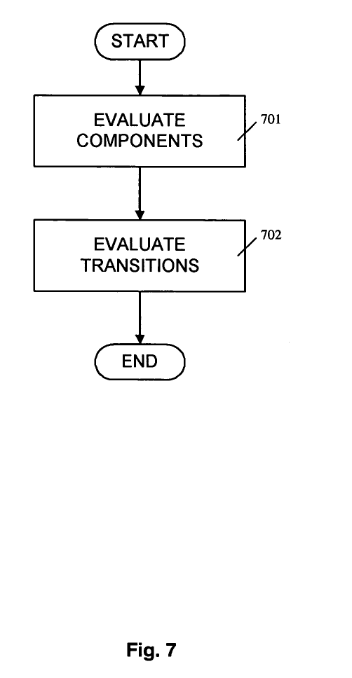

As shown in FIG. 1, in step 102 the components 201 and transitions 202 of the high level abstraction 200 are automatically evaluated and expanded to create AV assets and an intermediate data structure of nodes and links. FIG. 7 shows the step 102 of FIG. 1 in more detail.

The components 201 and transitions 202 may be evaluated in any order. However, but it is convenient to first evaluate the components and then to evaluate the transitions. Ideally, any meta-components in the abstraction are evaluated first. Where a meta-component results in new components and transitions, these are added to the abstraction until all meta-components have been evaluated, leaving only information components and parameterised choice components.

An expanded intermediate data structure is created to represent the abstract components 201 and transitions 202 in the new evaluated form. This expanded data structure comprises branching logic derived from the events 203 attached to the transitions 202 (which will eventually become navigation data in the desired audiovisual product) and nodes associated with AV assets derived from the components 201 (which will eventually become presentation data in the audiovisual product). However, it is not intended that the expanded data structure is yet in a suitable form for creating an audiovisual product in a restricted format such as a DVD-video product, since at this stage there is no mapping onto the hierarchical structure and other limitations of the DVD-video specification.

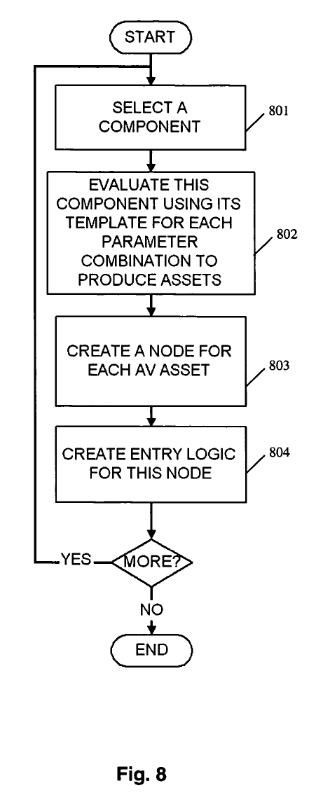

FIG. 8 shows step 701 of FIG. 7 in more detail, to explain the preferred method for evaluating the components 201. As shown in FIG. 8, each information component 201a and each choice component 201b is selected in turn in step 801. Each component 201 is evaluated to provide one or more AV assets in step 802. In an information component, this evaluation comprises creating an AV asset from the referenced raw content objects 304. In a choice component, this evaluation step comprises evaluating a template 305 and one or more raw content objects 304 according to the authoring parameters 301/302 to provide a set of AV assets. Suitably, a node in the expanded data structure is created to represent each AV asset, at step 803. At step 804, entry logic and/or exit logic is created to represent a link to or from each node such that each AV asset is reached or left under appropriate runtime conditions.

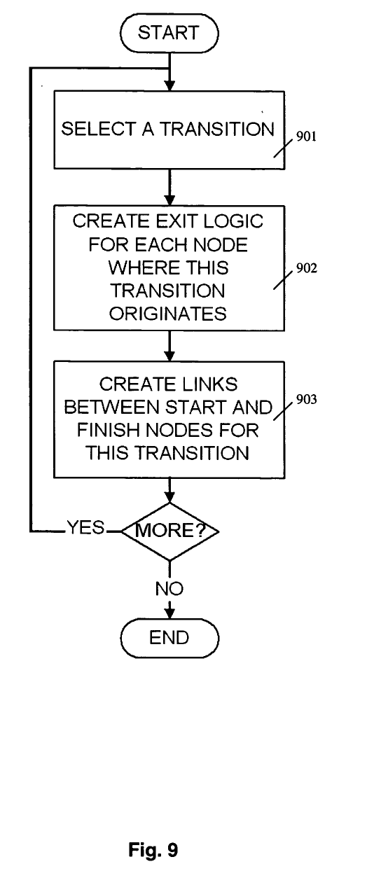

FIG. 9 shows a preferred method for evaluating transitions in step 702 of FIG. 7. Each transition 202 is selected in any suitable order in step 901. In step 902 the conditions of the triggering event 203 associated with a particular transition 202 are used to create entry and/or exit logic for each node of the expanded data structure. In step 903, explicit links are provided between the nodes.

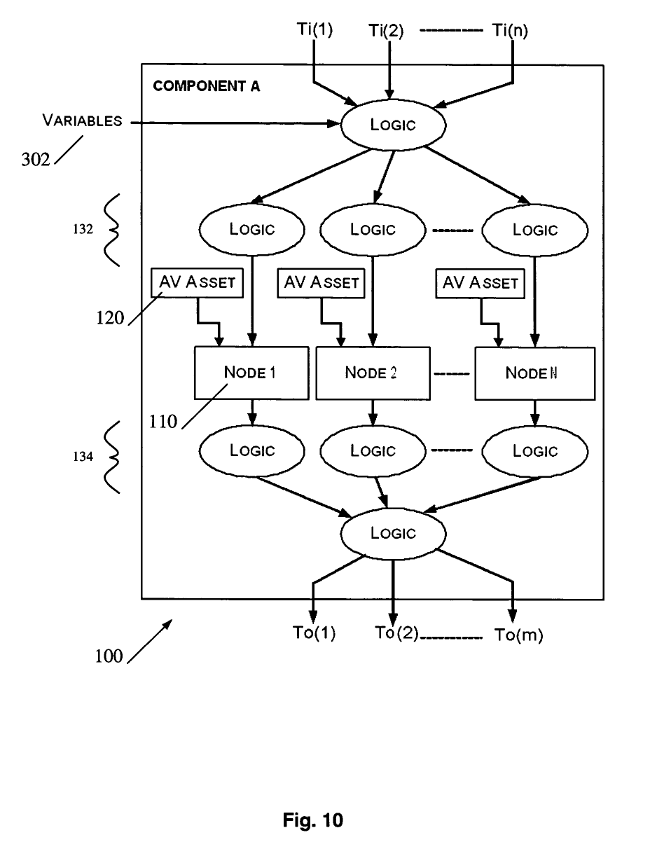

FIG. 10 is a schematic illustration of a component 201 during evaluation to create a set of nodes 110 each associated with an AV asset 120, together with entry logic 132 and exit logic 134, defining movement between one node 110 and the next. The entry logic 132 and exit logic 134 reference runtime variables 302 which are available during playback (e.g. timer events, player status, and playback states), and the receipt of user commands. Conveniently, the evaluation step consumes each of the authoring-only parameters 301 associated with the abstract components 201, such that only the runtime variables 302 and runtime actions such as timer events and user commands remain.

Referring again to FIG. 1, a conformance checking step 105 may, additionally or alternatively to the checking step 104, be applied following the evaluation step 102. Evaluation of the abstraction in step 102 to produce the expanded data structure 100 allows a more accurate prediction of expected compliance with a particular output specification. In particular, each node of the expanded data structure represents one AV asset, such that the total number of AV assets and object locations can be accurately predicted, and the set of AV assets has been created, allowing an accurate prediction of the capacity required to hold these assets. Conveniently, information about conformance or non-conformance is fed back to an operator. Changes to the structure of the product can then be suggested and made in the abstraction to improve compliance.

Referring to FIG. 1, in step 103 the expanded data structure from step 102 is used to create an audiovisual product according to a predetermined output format, in this case by creating specific structures according to a desired DVD-video specification.

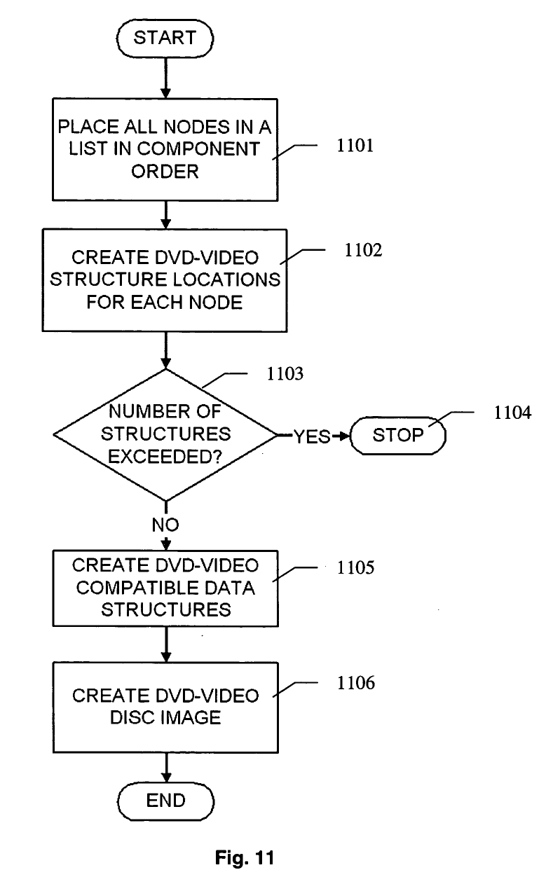

FIG. 11 shows an example method for creation of the DVD video structures. In step 1101, the nodes 110 in the expanded data structure are placed in a list, such as in an order of the abstract components 201 from which those nodes originated, and in order of the proximity of those components to adjacent components in the abstraction. As a result, jumps between DVD video structure locations during playback are minimised and localised to improve playback speed and cohesion.

Each node is used to create a DVD video structure location at step 1102. Optionally, at step 1103 if the number of created DVD video structure locations exceeds the specified limit set by the DVD-video specification then creation is stopped at 1104 and an error reported. Assuming the number of structures is within the specified limit then DVD video compatible data structures are created at step 1105. Finally, a DVD-video disc image is created at step 1106. Conveniently, commercially available tools are used to perform step 1106 and need not be described in detail here.

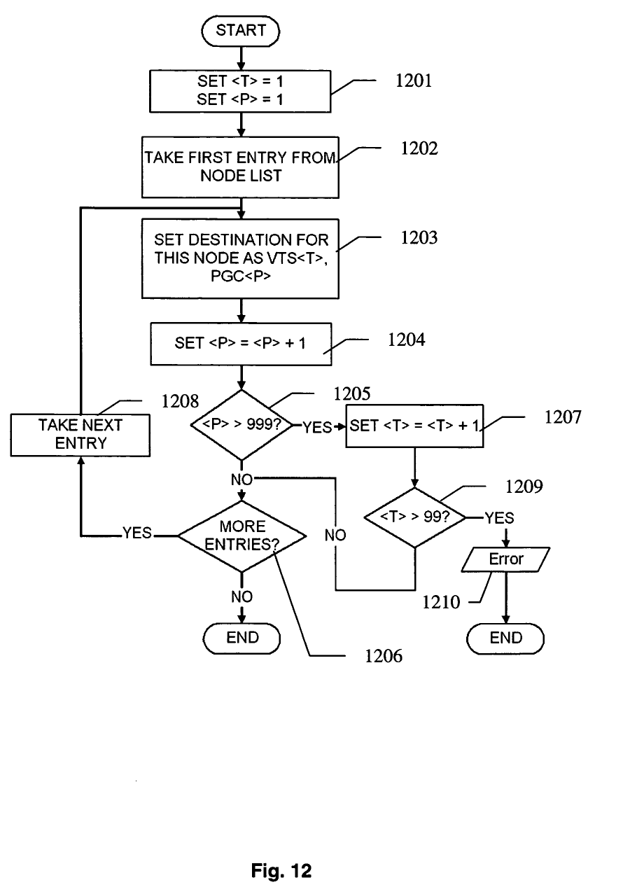

Step 1102 is illustrated in more detail in FIG. 12. In this example variable T represents a number of a video title set VTS (ie. from 1-99) whilst variable P represents a program chain PGC (ie. from 1-999) within each video title set. As shown in FIG. 12, the nodes 110 of the expanded data structure 100 are used to define locations in the video title sets and program chains. As the available program chains within each video title set are consumed, then the locations move to the next video title set. Here, many alternate methods are available in order to optimise allocation of physical locations to the nodes of the expanded data structure.

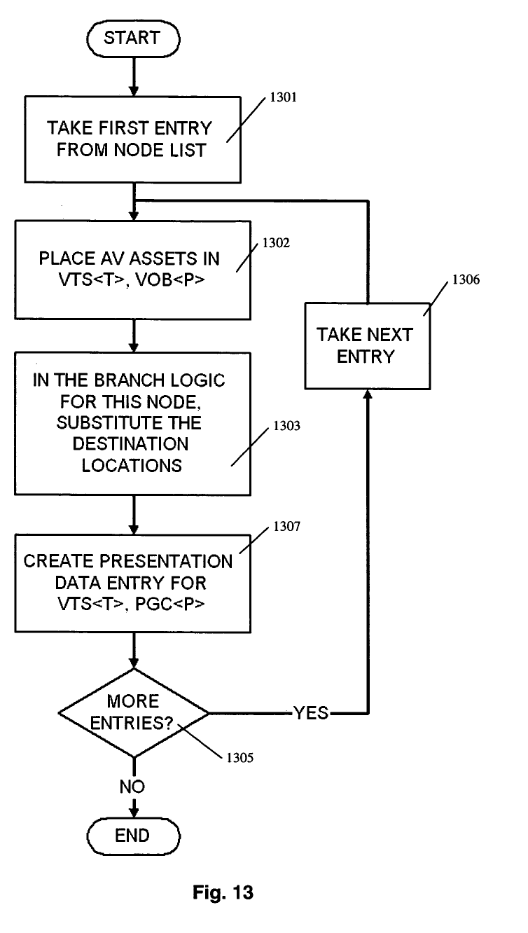

Step 1105 of FIG. 11 is illustrated in more detail in FIG. 13. FIG. 13 shows a preferred method for creating DVD-video compatible data structures by placing the AV assets 120 associated with each node 110 in the structure location assigned for that node and substituting links between the nodes with explicit references to destination locations. At step 1307 this results in an explicit DVD compatible data structure which may then be used to create a DVD disc image. Finally, the DVD disc image is used to record a DVD disc as a new audiovisual product.

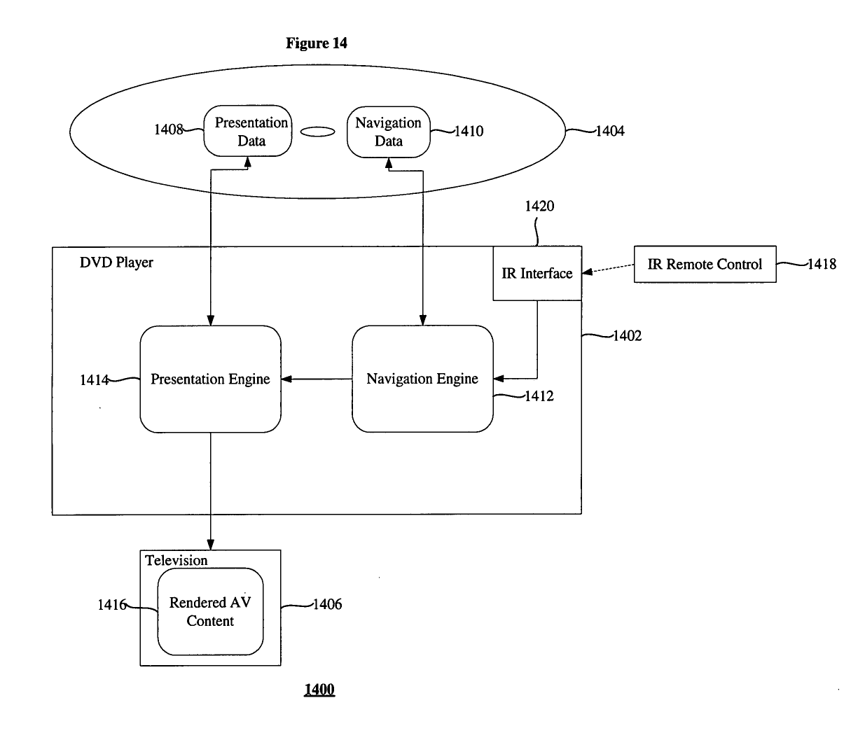

FIG. 14 shows, schematically, a typical home entertainment system 1400 comprising a DVD player 1402, a DVD 1404 and a television 1406. The DVD 1404 comprises presentation data 1408 and navigation data 1410. The navigation data 1410 is used by a navigation engine 1412 within the DVD player 1402 to control the order or manner of presentation of the presentation data 1408 by a presentation engine 1414. The presentation engine 1414 presents the presentation data 1408 on the television 1406 as rendered audiovisual content 1416. As is well known within the art, the rendered audiovisual content 1416, conventionally, takes the form of a movie or photographic stills or text associated with that movie. It will be appreciated that a navigation manager represents, or represents at least part of, an embodiment or a navigation engine or controller. Similarly, a presentation engine represents an embodiment of at least part of a presentation engine or controller.

The presentation data and navigation data, that is, the DVD-video disc image data, comprises audiovisual content that is derived from raw content objects, which include audio content and visual content, and structured according to a navigation plan that reflects desired transitions and relationships between the parts of the audiovisual content or the raw content objects used to produce the audiovisual content. Within an authoring tool, the raw content objects are represents by respective abstractions that are typically icons. It will be appreciated that, for example, such abstractions can be a “scenario” that is produced by the Scenarist product available from Sonic Solutions.

A user (not shown) can use a remote control 1418 associated with the DVD player 1402 to influence the operation of the navigation engine 1412 via an infrared remote control interface 1420. The combination of the infrared remote control 1420 and the navigation engine 1412 allows the user to make various selections from any menus presented by the presentation engine 1414 under control of the navigation engine 1412 as mentioned above.

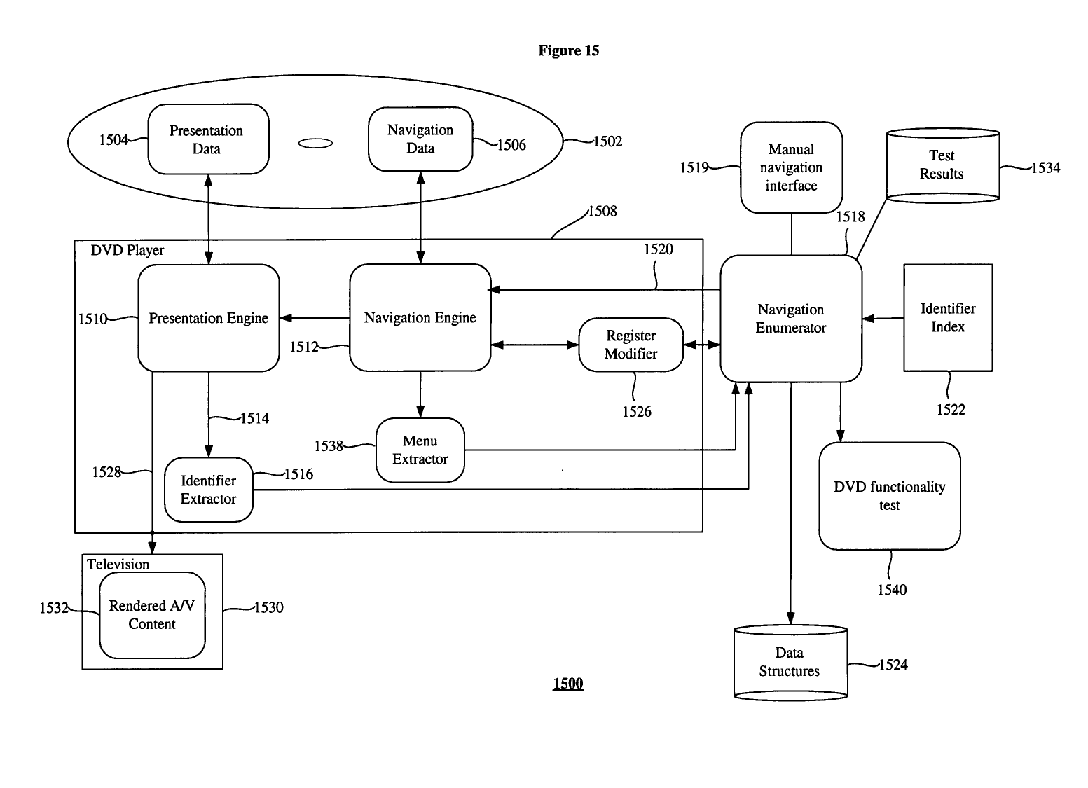

Referring to FIG. 15, there is shown a testing arrangement 1500 using an embodiment of the present invention. FIG. 15 shows a DVD disc 1502 storing presentation data 1504 and navigation data 1506. The DVD player 1508 comprises a respective presentation engine 1510 and navigation engine 1512. In preferred embodiments, the DVD player 1508 is a software player, that is, it is executable by a computer such as, for example, a desk-top PC or other computer.

It will be appreciated that the presentation data 1504 comprises a number of audiovisual assets (not shown). The video assets are encoded during the authoring process to have an associated unique identifier. Alternatively, only selected video assets might be encoded with such an associated unique identifier. For example, when encoding video data, that is, a video sequence, to produce a corresponding MPEG video stream, the unique identifier might be placed in the user_data field of the MPEG video stream as defined by the MPEG-2 standard, which is incorporated herein by reference for all purposes. The unique identifier allows the associated video asset to be identified. In a preferred embodiment, the presentation engine 1510 processed the presentation data stream 1514 using an identifier extractor 1516. The identifier extractor 1516 extracts the data representing the unique identifier from the user_data field of the MPEG elementary video stream 1514 and forwards the unique identifier to a navigation enumerator 1518.

In preferred embodiments, the unique identifiers are embedded within the MPEG streams during authoring. This has the advantage that an association can be created more readily between a unique identifier and the abstraction representing the raw content or raw content object from which the MPEG stream is derived. Alternatively, or additionally, prior to testing audiovisual content, the content can be traversed to assign unique identifiers to each, or selected, MPEG streams, which will allow the navigation through that content to be tracked using the unique identifiers.

The navigation enumerator 1518, in effect, replaces the infrared remote control 1418 mentioned above. The navigation enumerator 1518 generates control signals that influence the operation of the navigation engine 1512 in substantially the manner as the infrared signals influence the operation of the navigation engine 1512. The navigation enumerator 1518 is responsive to a functionality test plan 1540. The functionality test plan 1540 comprises a high level abstraction of the data anticipated to be contained on the disc. The test plan contains an expectation of the paths through the data contained on the disc together with a high-level abstraction of the elements anticipated as representing that data. In preferred embodiments, the test plan might comprise at least one of a start point, which can be defined in terms of initialisation data for initialising the DVD player's registers, for example, an indication of anticipated events or outputs expected to be produced by the player, unique identifiers associated with those events or outputs and commands that are intended to simulate menu selections or button commands, that is, user input actions. The navigation enumerator 1518 comprises a copy of each identifier incorporated into the presentation data 1504 together with respective references to high level abstractions of the assets associated with the unique identifiers. In preferred embodiments, the high level abstractions or data structures that correspond to the various assets forming the presentation data 1504 are stored on an HDD 1524. Upon receiving a unique identifier from the identifier extractor 1516, the navigation enumerator 1518 uses that identifier to obtain a reference to the high level abstraction corresponding to the unique identifier via the identifier index 1522. The high level abstraction associated with the unique identifier is obtained, using the reference, from the high level abstractions or data structures stored on the HDD 1544. The retrieved high level abstraction or data structures are compared with high level abstraction or data structures forming part of the test plan 1540 to determine with there is a match or correlation between them according to a current position within the test plan. Alternatively, the extracted unique identifier is compared to an anticipated unique identifier to determine whether or not the content is being retrieved and processed as anticipated. The current position within the test plan is maintained or managed by the navigation enumerator. The current position within the test plan 1540 corresponds to the next high-level data abstraction anticipated to match the next unique identifier, and, consequently, the next video sequence, retrieved from the presentation data stream 1514. If there is a match or correlation between the two high-level abstractions, the navigation enumerator creates a record to that effect. If there is not a match or correlation between the two high-level data abstractions, the navigation enumerator creates a record to that effect. In preferred embodiments the record contains an indication of the unique identifier together with an indication of the high-level abstraction associated with that identifier and the high-level abstraction anticipated as being identified by the test plan. The records are stored in a respective file 1534 created by the navigation enumerator. Alternatively, or additionally, the record might comprise visual information of what was expected and what was actually produced. For example, screen shots or video sequences of the actual output of the presentation engine might be stored within the record. Optionally, the anticipated screen shots or video sequences might also be stored within the record.

A register modifier 1526, forming part of the DVD player 1508, is used to read and/or modify the settings of the GPRMs and SPRMs of the DVD player 1508. The register modifier 1526 is operated under the control of the navigation enumerator 1518 to cause the navigation engine to access and give effect to the navigation data 1506 in a pre-determined manner or according to the requirements of the test plan 1540. In effect, the register modifier 1526 controls the traversal of the disc 1502 or access to the assets stored on the disc 1502 to allow each, or selected, navigation paths through the assets to be explored and associated audiovisual assets retrieved and rendered or processed to identify matches, or mismatches, between those assets with their anticipated high-level abstractions according to the test plan.

Preferably, the embodiments also comprise a menu extractor 1538. The menu extractor is used to intercept or process presentation data that identifies a current menu being processed. It will be appreciated that the presentation data can comprise menu data within or associated with an MPEG stream and that such an MPEG stream can have an associated unique identifier. Therefore, a unique identifier can also be used to identify a corresponding menu within the current presentation data stream. Hereafter, a unique identifier associated with a menu will be referred to as menu identification data. In preferred embodiments, the identifier index 1522 also contains a mapping between menu identification data and high-level abstraction data associated with such menu identification data. Again, the navigation enumerator 1518 uses the data output by the menu extractor 1538, in conjunction with the identifier index 1522 and the high-level abstraction data forming part stored on the HDD 1524, in a comparison with the test plan 1540 to determine whether the authored DVD is as anticipated.

In preferred embodiments, the DVD player 1502 comprises a manual navigation controller 1519 that presents an interface to a user (not shown) that can be used to influence the operation of the DVD player 1502. In preferred embodiments, the user interface of the manual navigation controller is used to create the tests plans and/or to select between previously created test plans.

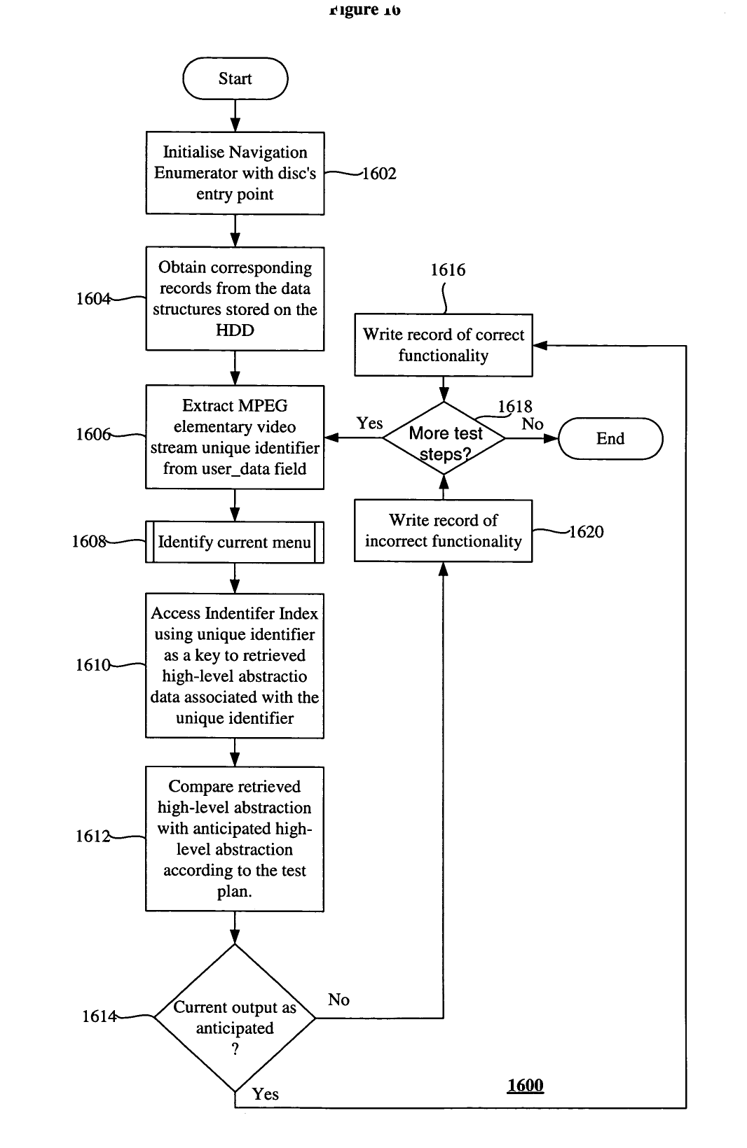

FIG. 16 shows a flowchart 1600 for testing the functionality of a DVD according to an embodiment. At step 1602, the navigation enumerator is initialised with the disc's entry point or, in the general case, a desired entry point. It will be appreciated that using a desired entry point, rather than a disc's start entry point, has the advantage that functionally separate parts of the disc or content can be tested in isolation. This allows testing to be made more efficient, especially when options are encountered. Rather than testing all content preceding an option for every option at a particular decision point, the start point for the test can be the decision point, with the preceding content having been previously tested or assumed to be functionally correct. The initialisation establishes the point within the high level abstraction of the disc 1502 contained within the test plan 1540 at which the comparison between the content of the test disc 1502 and the anticipated content of that disc is commenced. It will be appreciated that when testing the complete disc, one skilled in the art might usually start from the discs initial entry point. The high-level abstractions stored on the HDD corresponding to the disc's entry point are retrieved by the navigation enumerator 1518 at step 1604. The unique identifier is read from the user_data field of the MPEG elementary video stream processed by the presentation engine 1510 in response to the navigation engine 1512 responding to the navigation enumerator's 1518 commands to obtain the first, or a current, MPEG elementary video stream.

At step 1608, the current menu being processed by the navigation engine 1512 is identified. The identifier index is accessed using the extracted unique identifier to identify, within the high-level abstractions stored on the HDD 1524, the corresponding abstraction corresponding to that unique identifier. It will be appreciated that the test might call for actuation of a button. Therefore, the navigation enumerator 218 simulates actuation of that button by providing appropriate signalling to the navigation engine.

A comparison is performed, at step 1612, between the retrieved high-level abstraction corresponding to the unique identifier and an high-level abstraction anticipated as being encountered next by the test plan. A test is performed, at step 1614, to determine whether the currently processed, or output, video data or video signals are as anticipated, that is, it is determined whether or not there is a match between the high-level abstraction of the current assets and the anticipated high-level abstraction according to the test plan 1540. If the determination is positive, a record is written to the test results file 1534 providing an indication to that effect. A determination is made at step 1618 as to whether or not there are further test steps to be performed within a current test. If the determination at step 1618 is positive, processing proceeds from step 1606 where the next MPEG elementary video stream is processed to extract its corresponding unique identifier. However, if the test at step 1618 is negative, testing of the DVD is deemed to be complete and processing terminates. If the test at 1614 is negative, a record is written to the test results file 1534 containing an indication to that effect, where after processing proceeds from step 1618. It will be appreciated in practice that the storage of the test results and the tests or test plans will be achieved using the same HDD or the like.

It will be appreciated that the steps of FIG. 16 represent the execution or processing associated with a single test. Embodiments can be realised in which a test plan comprising multiple tests is executed. In such embodiments, the processing shown in FIG. 16 will be executed multiple times.

Preferred embodiments of the present invention are realised in the form of a software DVD player that is modified to allow the presentation engine 1510 to extract an output the unique identifier contained within the user_data field of the MPEG elementary video stream. Such an embodiment is also modified to allow the navigation engine or navigation manager 1512 to output data identifying the current menu to allow the menu extractor 1538 to inform the navigation enumerator 1518 of the current menu. In preferred embodiments, the menu extractor 1538 forms part of the navigation engine 1512.

Although the above embodiments use a unique identifier inserted into the user_data field of the MPEG elementary video stream as a reference, embodiments are not limited to such an arrangement. Embodiments can be realised in which, for example, the video stream has some other form of associated unique identifier data. For example, the MPEG elementary video stream might comprise a finger print that can be extracted by the identifier extractor and used as a reference to allow the navigation enumerator to correlate a current position on, or event associated with, the data stored on the disc with the data structures stored on the disc with the data structures stored on the HDD. Alternatively, or additionally, the video represented by the MPEG elementary video stream might comprise “line 21” data. In effect, the “line 21” data comprises a unique identifier associated with each, or selectable, video sequences to be processed during authoring.

The DVD authoring method and apparatus described above have a number of advantages. Creating components that represent parameterised sections of audio visual content allow many individual AV assets to be implicitly defined and then automatically created. Repetitive manual tasks are avoided, which were previously time consuming, expensive and error-prone. The authoring method and apparatus significantly enhance the range of features available in existing categories of audiovisual products or content such as movie presentations. They also allow new categories of audiovisual products or content to be produced. These new categories include both entertainment products or content such as quiz-based games and puzzle-based games, as well as information products such as catalogues, directories, reference guides, dictionaries and encyclopaedias. In each case, the authoring method and apparatus described herein allow full use of the video and audio capabilities of DVD specifications such as DVD-video. A user may achieve playback using a standard DVD player with ordinary controls such as a remote control device. A DVD-video product having highly complex navigational content is readily created in a manner that is simple, efficient, cost effective and reliable.

Although a few preferred embodiments have been shown and described, it will be appreciated by those skilled in the art that various changes and modifications might be made without departing from the scope of the invention, as defined in the appended claims.

The term “audiovisual product” comprises at least any one of data representing audiovisual content, DVD-video disc image data, data compliant with the DVD specification or a medium storing such data.

Although the above embodiments have been described with reference to the product being playable by a “standard DVD player”, it will be appreciated that other players can equally well be accommodated such as, for example, software players, set-top boxes or other means of processing or otherwise rendering audiovisual content using hardware or software or a combination of hardware and software.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings) and/or all of the steps of any method or process so disclosed may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

1. An authoring method for use in creating an audiovisual product, comprising the steps of:
defining a plurality of components, the components implicitly representing functional sections of audiovisual content with respect to one or more raw content objects, and a plurality of transitions that represent movements between the plurality of components;
expanding the plurality of components and the plurality of transitions to provide a set of explicitly realized AV assets and an expanded intermediate data structure of nodes and links, where each node is associated with an AV asset of the set and the links represent movement from one node to another;
creating an audiovisual product in a predetermined output format, using the AV assets and the expanded intermediate data structure of the nodes and the links; and
testing the audiovisual product.

2. The method of claim 1, wherein the defining step comprises defining at least one information component that comprises a reference to a raw content object.

3. The method of claim 2, wherein the reference denotes a file path to a location where the raw content object is stored.

4. The method of claim 1, wherein the defining step comprises defining at least one choice component comprising a reference to at least one raw content object, and at least one authoring parameter.

5. The method of claim 4, wherein the at least one authoring parameter is adapted to control a selection or modification of the at least one raw content object.

6. The method of claim 4, wherein the at least one authoring parameter comprises a runtime variable available during playback of the audiovisual product.

7. The method of claim 4, wherein the at least one authoring parameter comprises an authoring-only parameter that will not be available during playback of the audiovisual product.

8. The method of claim 4, wherein the choice component comprises a reference to a presentation template and a reference to at least one substitutable raw content object to be placed in the template according to the at least one authoring parameter.

9. The method of claim 1, wherein the defining step comprises defining at least one meta-component representing a set of components and transitions.

10. The method of claim 9, wherein the at least one meta-component is a procedurally defined representation of the set of components and transitions.

11. The method of claim 1, wherein each transition represents a permissible movement from one component to another component.

12. The method of claim 1, wherein each transition is associated with a triggering event.

13. The method of claim 12, wherein the triggering event is an event occurring during playback of the audiovisual product.

14. The method of claim 13, wherein the triggering event is receiving a user command, or expiry of a timer.

15. The method of claim 1, further comprising the step of checking expected conformance of the audiovisual product with the predetermined output format, using the plurality of components and the plurality of transitions.

16. The method of claim 15, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

17. The method of claim 15, wherein the checking step comprises predicting an expected total size of the audiovisual product, and comparing the expected total size against a storage capacity of a predetermined storage medium.

18. The method of claim 1, wherein the expanding step comprises, for each component, building one or more of the set of explicitly realized AV assets by reading and manipulating the one or more raw content objects.

19. The method of claim 18, wherein:
the defining step comprises defining at least one choice component comprising a reference to a plurality of raw content objects and at least one authoring parameter; and
the building step comprises:
selecting one or more raw content objects from amongst the plurality of raw content objects using the at least one authoring parameter; and
combining the selected raw content objects to form one of the AV assets.

20. The method of claim 19, comprising repeating the selecting and combining steps to automatically build a plurality of the explicitly realized AV assets from the one of the components.

21. The method of claim 1, wherein the expanding step comprises:
creating from each one of the plurality of components one or more explicitly realized AV assets to provide the set of AV assets;
creating the expanded intermediate data structure wherein each node represents one AV asset of the set; and
creating a set of links between the nodes.

22. The method of claim 21, wherein each transition is associated between first and second components, and creating the set of links comprises evaluating each transition to create one or more links, each of the links being between a node created from the first component and a node created from the second component.

23. The method of claim 1, wherein the expanding step comprises evaluating at least one of the transitions to create exit logic associated with at least one first node, evaluating one of the components to create entry logic associated with at least one second node, and providing a link between the first and second nodes according to the entry logic and the exit logic.

24. The method of claim 23, wherein at least one of the transitions is associated with a triggering event, and the expanding step comprises evaluating the triggering event to determine the exit logic associated with the at least first one node.

25. The method of claim 1, further comprising the step of checking expected conformance of the audiovisual product with the predetermined output format, using the AV assets and the expanded intermediate data structure of nodes and links.

26. The method of claim 25, wherein the predetermined output format is a hierarchical data structure having limitations on a number of objects that may exist in the data structure at each level of the hierarchy, and the checking step comprises predicting an expected number of objects at a level and comparing the expected number with the limitations of the hierarchical data structure.

27. The method of claim 26, wherein the checking step comprises predicting an expected total size of the audiovisual product, and comparing the expected total size against a storage capacity of a predetermined storage medium.

28. The method of claim 1, wherein the AV assets have a data format specified according to the predetermined output format.

29. The method of claim 1, wherein the AV assets each have a data format according to the predetermined output format, whilst the raw content objects are not limited to a data format of the predetermined output format.

30. The method of claim 1, wherein the predetermined output format is a DVD-video specification.

31. The method of claim 1, wherein the AV assets each comprise a video object, zero or more audio objects, and zero or more sub-picture objects.

32. The method of claim 1, wherein the AV assets each comprise at least one video object, zero to eight audio objects, and zero to thirty-two sub-picture objects, according to the DVD-video specification.

33. The method of claim 1, wherein the creating step comprises creating objects in a hierarchical data structure defined by the predetermined output format with objects at levels of the data structure, according to the intermediate data structure of nodes and links, and where the objects in the hierarchical data structure include objects derived from the explicitly realised realized AV assets.

34. The method of claim 1, wherein the predetermined output format is a DVD-video specification and the creating step comprises creating DVD-video structure locations from the nodes of the expanded intermediate data structure, placing the explicitly realized AV assets at the created structure locations, and substituting the links of the expanded intermediate data structure with explicit references to the DVD-video structure locations.

35. An authoring method for use in creating a DVD-video product, comprising the steps of:
creating a plurality of components representing parameterized sections of audiovisual content, and a plurality of transitions representing movements between components;
expanding the plurality of components and the plurality of transitions to provide a set of AV assets and an expanded data structure of nodes and links, where each node is associated with an AV asset of the set and the links represent movement from one node to another;
creating a DVD-video format data structure from the AV assets, using the nodes and links; and
testing the DVD-video format data structure.

36. The method of claim 35, comprising creating at least one information component comprising a reference to an item of AV content.

37. The method of claim 35, comprising creating at least one choice component comprising a reference to at least one item of AV content, and at least one parameter for modifying the item of AV content.

38. The method of claim 37, wherein the choice component comprises a reference to a presentation template and a reference to at least one item of substitutable content to be placed in the template according to the at least one parameter.

39. The method of claim 37, wherein the choice component comprises at least one runtime variable available during playback of an audiovisual product in a DVD player, and at least one authoring parameter not available during playback.

40. The method of claim 35, comprising creating at least one meta-component representing a set of components and transitions.

41. The method of claim 35, wherein each transition represents a permissible movement from one component to another component, each transition being associated with a triggering event.

42. The method of claim 41, wherein a triggering event includes receiving a user command, or expiry of a timer.

43. The method of claim 35, wherein the expanding step comprises:
creating from each one of the plurality of components one or more AV assets to provide the set of AV assets;
creating the expanded data structure wherein each node represents one AV asset of the set; and
creating a set of links between the nodes.

44. The method of claim 37, wherein the expanding step comprises evaluating each choice component to create a plurality of AV assets according to each value of the at least one parameter.

45. The method of claim 44, wherein evaluating each choice component comprises creating entry logic associated with at least one node and/or evaluating at least one transition to create exit logic associated with at least one node, and providing a link between a pair of nodes according to the entry logic and the exit logic.

46. The method of claim 35, comprising the step of checking expected conformance with the DVD-video format using the created components and transitions.

47. The method of claim 35, comprising the step of checking expected conformance with the DVD-video format using the set of AV assets and the expanded data structure of nodes and links.

48. An authoring method for use in creating an audiovisual product according to a DVD-video specification, comprising the steps of:
generating a set of AV assets each comprising a video object, zero or more audio objects and zero or more sub-picture objects, and an expanded data structure of nodes and links, where each node is associated with one AV asset of the set and the links represent navigational movement from one node to another; and
creating a DVD-video format data structure from the set of AV assets, using the nodes and links;
the method further characterized by the steps of:
creating a plurality of components and a plurality of transitions, where a component implicitly defines a plurality of AV assets by referring to a presentation template and to items of raw content substitutable in the presentation template, and the plurality of transitions represent navigational movements between components;
expanding the plurality of components and the plurality of transitions to generate the set of AV assets and the expanded data structure of nodes and links; and
testing the set of AV assets and the expanded data structure of nodes and links.

49. A method as claimed in claim 48 in which the step of testing comprises the steps of selecting and processing a data stream or audiovisual product, comprising data representing at least one of audiovisual data and identification data, to extract the identification data, using the identification data to access an abstraction associated with the identification data; comparing the abstraction with an anticipated abstraction associated with a test plan; and outputting an indication of the result of the comparison.

50. A method as claimed in claim 49, in which the step of outputting comprises the step of creating a record of the comparison; the record providing an indication of whether or not the retrieved high-level abstraction matched the anticipated high-level abstraction.

51. A method as claimed in claim 49 in which the step of processing the data stream or audiovisual product comprises the step of extracting the identification data from a user field of an encoded elementary video stream.

52. A method as claimed in claim 49 in which the step of processing the data stream or audio visual product comprises the step of identifying a current menu associated with the data stream or audio visual product.

53. A method as claimed in claim 52 further comprising the step of identifying menu option data, representing at least one option, associated with the current menu and invoking at the at least one option to select and process a next data stream or audiovisual product or portion thereof.

54. A method as claimed in claim 49 further comprising the step of creating the test plan.

55. A method as claimed in claim 54 wherein the step of creating the test plan comprises the steps of creating at least one of an anticipated unique identifier, an abstraction anticipated as being associated with a unique identifier, an actual abstraction associated with the unique identifier, entry conditions or status information and command information.

56. A method as claimed in claim 54 in which the step of creating the test plan comprises the step of associating the identification data of the data stream or audiovisual product with an anticipated abstraction representing audiovisual content of the data stream or audiovisual product.

57. A method as claimed in claim 49 further comprising the step of creating an index comprising an identification data entry for storing a copy of the identification data, and at least a reference to a corresponding abstraction; and in which the step of comparing comprises the step of access the index using the identification data as a key to identify the corresponding abstraction.

58. (canceled)

59. A system comprising means to implement a method as claimed in claim 1.

60. A program comprising executable code to implement a system or method as claimed in claim 1.

61. A program product comprising storage for storing a program as claimed in claim 60.

62. A DVD comprising presentation data and navigation data together with associated identification data.

63. A method of authoring a DVD, comprising the steps of generating a unique identifier for a respective video sequence and encoding the respective video sequence to comprise the unique identifier or to establish an association with the unique identifier.
